(19) United States
(12) Patent Application Publication
(10) Pub. No.: US 2006/0272902 A1
(43) Pub. Date: Dec. 7, 2006

(54) Elevator car operating panels

(76) Inventor: Slavomir Olejar, Toronto (CA)

Correspondence Address: SLAVOMIR OLEJAR, 6 ROBINGLADE DR., TORONTO, ON, M9B-2R1, CA

(21) Appl. No.: 11/144,913

(22) Filed: Jun. 6, 2005

(51) Int. Cl. B66B 1/34

(52) U.S. Cl. 187/395

(57) ABSTRACT

In an elevator, the buttons are disposed on an operating panel. In hallways, the call buttons are disposed on the call panel. Their function is to serve the user to select a preferred floor or to call the elevator car. In this invention, the floor selection and elevator call buttons have an additional “undo” function. This function is accomplished by pressing of the same button for the second time. If user has selected a wrong floor or changes his/her mind after selecting, the previous entry can be “undone” by pressing the selection button for the second time. The same principle applies to the call button. Both the selection and the call buttons behave as “on-off” switch on the circuit enabling selection, de-selection and re-selection of the same button for unlimited times.

### BACKGROUND

This invention relates generally to the elevator controls and, in particular, to an operating panel in an elevator car, and to the elevator call panels on the floors.

Current devise of operating panels does not allow user to cancel already entered selection of the destination floor and re-enter again the same, or a different one.

Current devise of call panels also does not allow user to cancel already entered elevator car call and re-enter it again.

### SUMMARY OF THE INVENTION

The present invention concerns a method for canceling the selected destination floor on the elevator car's operating panel, and the elevator call cancellation on the call panels, increasing the overall elevator usage efficiency.

The current floor selection buttons are disposed on the elevator car operating panels having the single functionality: to enter the floor selection into an elevator car operating system.

The current elevator call buttons are disposed on the call panels at each level in the building where elevator service is provided, having the single functionality: to enter the elevator car call into an elevator car operating system.

Additional “undo” functionality can be assigned to the existing buttons. This newly added functionality deletes from the system the last entry made with that particular button.

Abovementioned “undo” functionality is accomplished by pressing of the same button for the second time. If user has selected a wrong floor or changes his/her mind after selecting, the previous entry can be “undone” by pressing the same selection/call button for the second time, thus “switching off” the previous selection.

Both the selection and the call buttons behave as “on-off” switch on the circuit enabling selection, de-selection and re-selection of the same button for unlimited times.

### DESCRIPTION OF THE EMBODIMENT

Buttons on elevator car panel and buttons on the elevator car call panel behaves as “on-off” switches.

Selection of the button will change its current status switching it “off” if previously it was “on”, and switching it “on” if previously it was “off”.

Every time when user either enters or deletes the destination floor, or either makes or cancels the elevator call, the data is stored in the temporary memory, elevator system processor reads this entry, and floor sequence is recalculated. Elevator system processor reads the entered data from temporary memory in cycles.

Following describes the most common situations when the new feature could be applied:
If user has selected a floor or called the elevator and subsequently wanted to cancel this selection and made a different one, he/she will have to press the same button for the second time.
If user does not enter a new destination after said cancellation, elevator will continue running in the same direction to the next selected floor.
If user does not enter a new destination after said cancellation and there is not selected floor at all, the elevator will run to the next floor in the same direction, and stop.
If buttons on the operating or call panel have light or any signal indicating that floor or call was selected, second selection of the same button will change status of that indicator. For example, if after first selection the button's light is “on” indicating that certain floor has been selected or elevator called, after the second pressing of the same button the said light will go “off” indicating that cancellation has occurred, and the processor has recalculated the floors sequence.

What is claimed is:

1. An elevator control panel, where the selection cancellation is provided on said panel by subsequent selection of the same button. The subsequent selection deletes previous entry and changes status of the selection indicator if present.

2. An elevator call panel, where the selection cancellation is provided on said panel by subsequent selection of the same button. The subsequent selection deletes previous entry and changes status of the selection indicator if present.
